(19) United States
(12) Patent Application Publication
(10) Pub. No.: US 2010/0135740 A1
(43) Pub. Date: Jun. 3, 2010

(54) CUTTER APPARATUS AND METHOD

(75) Inventor: Gershon Harif, Ramat-Gan (IL)

Correspondence Address: THE NATH LAW GROUP, 112 South West Street, Alexandria, VA, 22314, US

(73) Assignee: G.R.G. PATENTS LTD., Holon (IL)

(21) Appl. No.: 12/532,295

(22) PCT Filed: Mar. 19, 2008
(86) PCT No.: PCT/IL08/00386

§ 371 Date: Sep. 21, 2009

(30) Foreign Application Priority Data
Mar. 22, 2007 (IL) 182152
Apr. 26, 2007 (IL) 182822
May 21, 2007 (IL) 183327

(51) Int. Cl. B23B 35/00

(52) U.S. Cl. 408/1 R

(57) ABSTRACT

A method of cutting a workpiece having a longitudinal axis including cutting the workpiece with a cutter tool, having a longitudinal axis, in one or more cutting strokes, is provided. Each stroke includes a relatively long unidirectional displacement between the cutter tool and workpiece along a first orthogonal axis; and a plurality of relatively short reciprocatory displacements between the cutter tool and workpiece along a second orthogonal axis perpendicular to the first orthogonal axis.

### FIELD AND BACKGROUND OF THE INVENTION

The present invention relates to cutter apparatus and methods for utilizing a cutter tool to remove selected portions of a workpiece during a cutting operation. For purposes of example, the invention is described below with respect to (a) a milling machine, wherein a cutter tool is rotated about its longitudinal axis while a drive system effectively displaces the workpiece and/or the cutter tool according to the particular cutting operations to be performed; and (b) a lathe-type machine, in which the workpiece is rotated about its longitudinal axis while the cutter tool is selectively displaced relative to the workpiece in accordance with the particular cutter operations to be performed.

Modern cutter apparatus, particularly of the numerical control (NC) type, is expensive to produce, install and operate, and therefore the machine time required to cut a workpiece into an article of a desired shape is a critical item of cost in manufacturing such articles. The substantial forces applied by the workpiece against the cutter tool, and the substantial heat generated between the cutter tool and the workpiece, during a cutting operation limit the rate at which the material can be removed from the workpiece without unduly stressing, or damaging, the cutter tool or the workpiece. This is illustrated in FIGS. 1a and 1b in the case of a milling machine, wherein the depth (H) at which the cutter tool can penetrate the workpiece without unduly straining the cutter tool is generally limited to about 0.4 times the diameter (d) of the cutter tool, as schematically illustrated in FIG. 1a. If the depth (H) exceeds 0.4 d, there is a danger that the cutter tool will be unduly strained so as to cause it to break, vibrate or overheat, during the cutting operation.

Overheating is also a serious limitation. For example, rotary cutter tools of high speed steel used in milling machines with water cooling are generally limited to a speed to 30 linear meters per minute to avoid overheating; whereas rotary cutter tools of tungsten-carbide are generally limited to a speed of 120 linear meters per minutes. The need to avoid overheating is generally to prevent damage to the cutter tool, but in some cases, also to prevent damage to the workpiece.

A similar problem arises with respect to lathe-type machines, wherein the workpiece is rotated about its longitudinal axis, while the cutter tool is used for slotting or shaping the workpiece. Also in this case, the depth of penetration of the cutter tool in the workpiece during a cutting operation is limited to avoid the possibility of breakage, vibration or overheating during the cutting operation.

### OBJECT AND BRIEF SUMMARY OF THE PRESENT INVENTION

An object of the present invention to provide cutter apparatus, and also a method of cutting workpieces, which permit material to be removed from a workpiece at a higher rate than in the conventional cutter apparatus, thereby substantially decreasing machine time for cutting workpieces.

According to one broad aspect of the present invention, there is provided cutter apparatus comprising a workpiece holder for holding a workpiece having a longitudinal axis, which workpiece is to be cut to a particular shape by removing selected portions thereof during one or more cutting strokes; a tool holder for holding a cutter tool having a longitudinal axis and cutter edges engageable with the workpiece to remove portions thereof during each cutting stroke; and a drive system operable, when the workpiece holder holds a workpiece and the cutter tool holder holds a cutter tool, for rotating one of the holders about its longitudinal axis and for bringing the cutter edges of the cutter tool into engagement with the workpiece to remove selected portions thereof during each cutting stroke; wherein, during each cutting stroke, the drive system effects: (a) a relatively long unidirectional displacement between the cutter tool and workpiece along a first orthogonal axis; and (b) a plurality of relatively short reciprocatory displacements between the cutter tool and workpiece along a second orthogonal axis perpendicular to the first orthogonal axis.

Several embodiments of the invention are described below for purposes of example.

In some described milling-machine embodiments, wherein the drive system rotates the cutter tool about its longitudinal axis, (e.g., in a milling machine), the second orthogonal axis of the relatively short reciprocatory displacements is parallel to the longitudinal axis of the cutter tool. In such embodiments, the cutter tool has cutter edges which become oriented, during each cutting stroke, to generate: (a) a lateral force, tending to move the cutter tool in the lateral direction perpendicularly to the longitudinal axis of the cutter tool; and (b) an axial force in the cutter tool imposing a substantial frictional resistance against movement of the cutter tool in the lateral direction.

In other described lathe-machine embodiments, wherein the drive system rotates the workpiece holder about its longitudinal axis, the cutter edges generating force (a) extend substantially parallel to the longitudinal axis of the cutter tool; and the cutter edges generating force (b) extend substantially perpendicularly to the longitudinal axis of the cutter tool.

In still other described milling-machine embodiments, wherein the drive system rotates the cutter tool about its longitudinal axis, the second orthogonal axis of the relatively short reciprocatory displacements is also perpendicular to the longitudinal axis of the cutter tool. In such embodiments, the cutter tool has axially-extending cutter edges such that in each of the relatively short reciprocatory displacements, the displacement in each direction causes the cutting edges on the leading side and only on one lateral side of the cutter tool to engage the workpiece, thereby substantially decreasing the lateral force applied to the cutter tool as well as the heat generated during the cutting operation. Accordingly, this enables the rate of travel of the cutter tool with respect to the workpiece to be substantially increased.

It will thus be seen that the mechanism of action involved in the latter embodiment is somewhat different from the mechanism of action involved in the previously described embodiments. Thus, whereas the previously described embodiments increase the holding resistance of the workpiece engaged portion of the cutter tool against the lateral force applied to it during a cutting operation, the latter described embodiment reduces the load applied at any one instant to the cutter tool during a cutting operation. Both arrangements also interrupt the surface of contact thereby permitting some of the heat to be dissipated, e.g., by natural radiation and/or by exposure to a coolant fluid, before recontact is made Both arrangements could conceivably be used together, or in the alternative, one arrangement could be used without the other.

A similar mechanism is involved in a lathe-type machine, wherein the workpiece (rather than the cutter tool) is rotated about its longitudinal axis during a cutting operation.

According to another aspect of the present invention, there is provided cutter apparatus comprising: a workpiece holder for holding a workpiece having a longitudinal axis, which workpiece is to be cut to a particular shape by removing selected portions thereof during one or more cutting strokes; a tool holder for holding a cutter tool having a longitudinal axis and cutter edges engageable with the workpiece to remove portions thereof during each cutting stroke; and a drive system operable, when the workpiece holder holds a workpiece and the cutter tool holder holds a cutter tool, for rotating one of the holders about its longitudinal axis and for bringing the cutter edges of the cutter tool into engagement with the workpiece to remove selected portions thereof during each cutting stroke; wherein, during each cutting stroke, the drive system effects: a relatively long unidirectional displacement between the cutter tool and workpiece along a first orthogonal axis; and periodical interruptions in the displacement of the cutter tool relative to the workpiece for a short period of time along the first orthogonal axis.

Preferably, the drive system, during each of the interruptions, reverses the direction of the displacement along the first orthogonal axis for the short period of time, to separate the cutter edges of the cutter tool from the workpiece. This allows for better heat dissipation and thereby a higher cutter speed during each cutting stroke.

According to a further aspect of the invention, there is provided a method of cutting a workpiece having a longitudinal axis in one or more cutting strokes each of which comprises: (a) a relatively long unidirectional displacement between the cutter tool and workpiece along a first orthogonal axis and (b) a plurality of relatively short reciprocatory displacements between the cutter tool and workpiece along a second orthogonal axis perpendicular to the first orthogonal axis.

According to a still further aspect of the present invention, there is provided a method of cutting a workpiece having a longitudinal axis by a cutter tool having a longitudinal axis in one or more cutting strokes, each of which comprises: a relatively long unidirectional displacement between the cutter tool and workpiece along a first orthogonal axis; and periodical interruptions in the displacement of the cutter tool relative to the workpiece for short periods of time along the first orthogonal axis.

As will be described more particularly below, such cutter apparatus, and method of cutting, can substantially increase the capability of the cutter tool to sustain the loads applied by the workpiece to the cutter tool during a cutting operation, and thereby substantially increase the rate of removal of material from the workpiece without unduly straining or overly heating the cutter tool of the workpiece.

Further features and advantages of the invention will be apparent from the description below.

### BRIEF DESCRIPTION OF THE DRAWINGS

The invention is herein described, by way of example only, with reference to the accompanying drawings, wherein:

FIGS. 1a and 1b are diagrammatic views briefly referred to above showing a critical limitation in the rate of removal of a cutter tool in a conventional milling machine to prevent unduly straining the cutter tool;

FIGS. 2a, 2b and 2c are various views illustrating one form of cutter tool constructed in accordance with the present invention;

FIGS. 3a and 3b are diagrams more particularly illustrating how the cutter tool constructed in accordance with FIGS. 2a-2c increases the capability of the cutter tool to sustain large loads applied by the workpiece during a cutting operation;

FIG. 4a-4f illustrates the various stages of a cutting operation using a cutter tool constructed in accordance with FIGS. 2a-2c;

FIGS. 5a and 5b are diagrams more particularly illustrating how the cutter tool constructed in accordance with FIGS. 2a-2c increases the heat dissipation generated by the cutter tool, thereby enabling the cutter tool to be operated at higher speeds;

FIG. 6 illustrates a cutter tool constructed and operated according to the diagrams of FIG. 4 but using detachable cutter heads to facilitate individual sharpening, repair or replacement of the cutter heads;

FIG. 7 diagrammatically illustrates another cutter tool constructed in accordance with the present invention particularly for use in a milling machine;

FIG. 8 illustrates a modification in the cutter tool of FIG. 7;

FIG. 9a is an enlarged fragmentary view of a portion of the cutter tool of FIG. 8, illustrating how the construction of the cutter tool increases its capability to sustain a large loads applied by the workpiece;

FIG. 9b illustrates a modification in the construction of the cutter tool illustrated in FIG. 9a;

FIGS. 10a and 10b are side and perspective views, respectively, illustrating another cutter head constructed in accordance with the present invention;

FIGS. 11a and 11b illustrate the manner in which upward reciprocations of the cutter head of FIGS. 10a and 10b eject the shavings during a cutting operation;

FIG. 12 is a perspective view illustrating another cutter tool constructed in accordance with the present invention for use in a milling machine, the cutter edges being formed in cutting sectors arranged in axial alignment;

FIG. 13 illustrates still another cutter tool constructed in accordance with the present invention wherein the cutter edges are formed in cutter sectors arranged in helical arrays;

FIG. 14 illustrates a cutter tool constructed in accordance with the present invention for use in a lathe-type machine, wherein the workpiece is rotated about its longitudinal axis and the cutter tool is displaced to remove selected portions of the workpiece;

FIGS. 15a-15c illustrate three displacement positions of the cutter tool when used in the machine of FIG. 15;

FIGS. 16 and 17 illustrate two modifications in the construction of the cutter tool of FIG. 14;

FIGS. 18a and 18b diagrammatically illustrate how the lathe-type cutter tool of FIGS. 14-15c permit better heat dissipation of the cutter tool, and thereby enable the cutter tool to be operated at a higher speed;

FIG. 19 diagrammatically illustrates another cutter apparatus constructed and operated in accordance with the present invention;

FIG. 20 diagrammatically illustrates the path of movement of the cutter tool of FIG. 19 during each cutting stroke, particularly the relatively long unidirectional displacement and the relatively short reciprocatory displacements between the cutter tool and workpiece;

FIG. 21 illustrates an example of a cutter tool particularly useful in the apparatus of FIG. 19;

FIGS. 22 and 23 illustrate other paths of movement of the cutter tool of FIG. 19 during each cutting stroke;

FIG. 24 diagrammatically illustrates a cutter machine operated according to both FIGS. 2-10 and FIGS. 15-19;

FIG. 25 diagrammatically illustrates the operation of the cutter apparatus wherein, during each cutting stroke, the drive system periodically interrupts the displacement of the cutter tool relative to the workpiece for a short period of time along the first orthogonal axis (the X-axis);

FIG. 26 diagrammatically illustrates the operation of FIG. 24, but wherein, during each interruption, the direction of displacement along the first orthogonal axis (the X-axis), is reversed for a short period of time;

FIG. 27 is a diagram illustrating how the operation of the cutter tool according to FIG. 24 or 25 increases the heat dissipation and thereby enables the cutter tool to be operated at a higher speed without overheating;

FIG. 28 is a diagram illustrating how the speed of operation of the cutter tool may be increased when operated according to the diagrams of either FIG. 24 or 25;

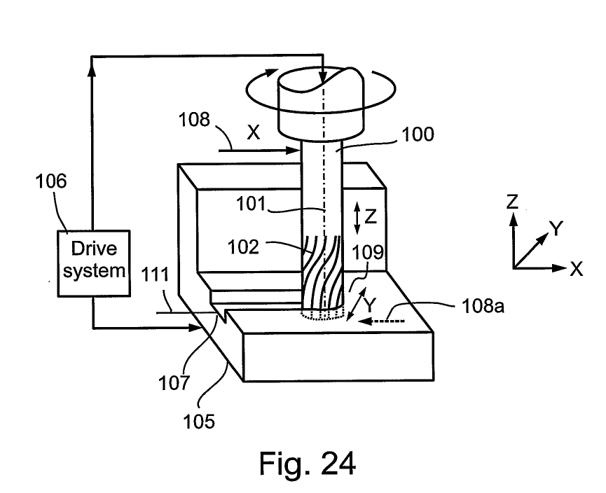

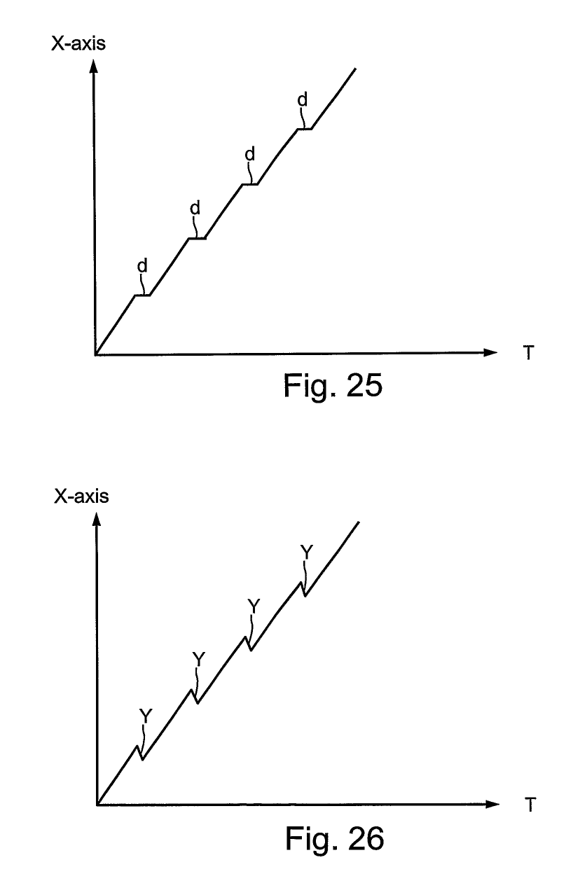

and FIGS. 29 and 30 are diagrams, corresponding to those of FIGS. 24 and 25, respectively, but illustrating the operation of the cutter tool when the reciprocatory displacements in the Y-axis and/or Z-axis are also periodically interrupted.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### THE PRIOR ART

### Prior Art Milling Machine

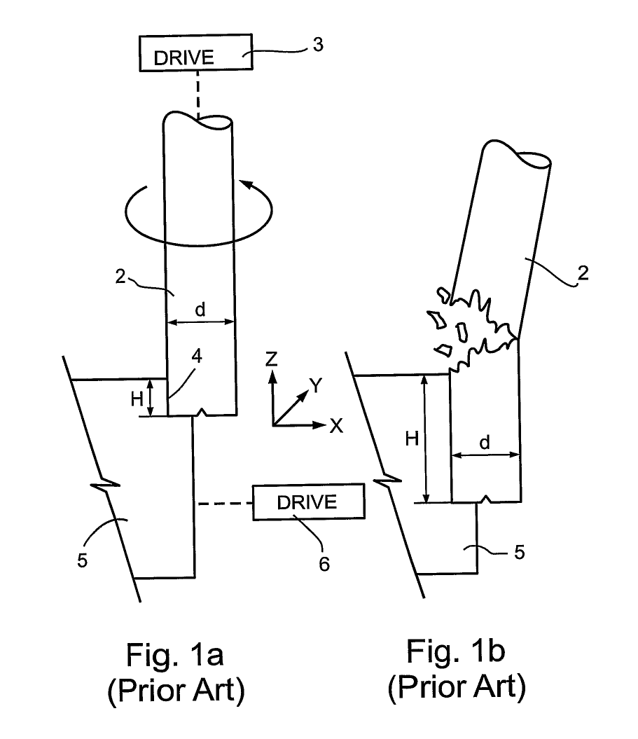

FIG. 1a schematically illustrates a cutting operation according to the prior art by using a conventional milling machine in which a cutter tool 2 is rotated about its longitudinal axis LA by a drive 3, while cutting edges 4 of the cutter tool engage a workpiece 5 driven by a drive 6 with respect to the cutter tool to remove selected portions of the workpiece. In the conventional milling machine, the cutter tool drive 3 rotates the workpiece 2 about its longitudinal axis, in this case the Z axis, and may also move the cutter tool along the Z axis; whereas the workpiece drive 6 moves the workpiece 5 along the X axis and Y axis, and possibly along the Z axis, according to the portions of the workpiece to be removed.

As briefly described above, in a conventional milling machine cutting operation, the cutter tool 2 is limited to a penetration depth (H) of about 0.4 times the diameter (d) of the cutter tool so as not to unduly strain the cutter tool, which may result in the breakage of the cutter tool as schematically indicated in FIG. 1b, or in creating undue vibrations in the cutter tool during the cutting operation. In addition, the cutter tool generates considerable heat during the cutting operation, and therefore the rotational speed must be limited to prevent overheating which could damage the cutter tool (and/or the workpiece). Accordingly, when using a conventional milling machine and cutter tool, cutting operations involving the removal of relatively large quantities of material from the workpiece require considerable machine time.

### DESCRIPTION OF PREFERRED EMBODIMENTS OF THE INVENTION

### General

The present invention provides cutter apparatus which permits the cutter tool to remove material from the workpiece at a faster rate without unduly straining and/or overheating the cutter tool. Briefly, this is done, according to one aspect of the present invention, by driving the cutter tool and the workpiece through one or more cutter strokes, in each of which the drive system effects a relatively long unidirectional displacement between the cutter tool and workpiece along a first orthogonal axis, and a plurality of relatively short reciprocatory displacements between the cutter tool and workpiece along a second orthogonal axis perpendicular to the first orthogonal axis. According to another aspect, overheating is prevented by periodically interrupting the displacement of the cutter tool relative to the workpiece for a short period of time along the first orthogonal axis (e.g., the X-axis), and/or along the second orthogonal axis (e.g., the Y-axis or the Z-axis).

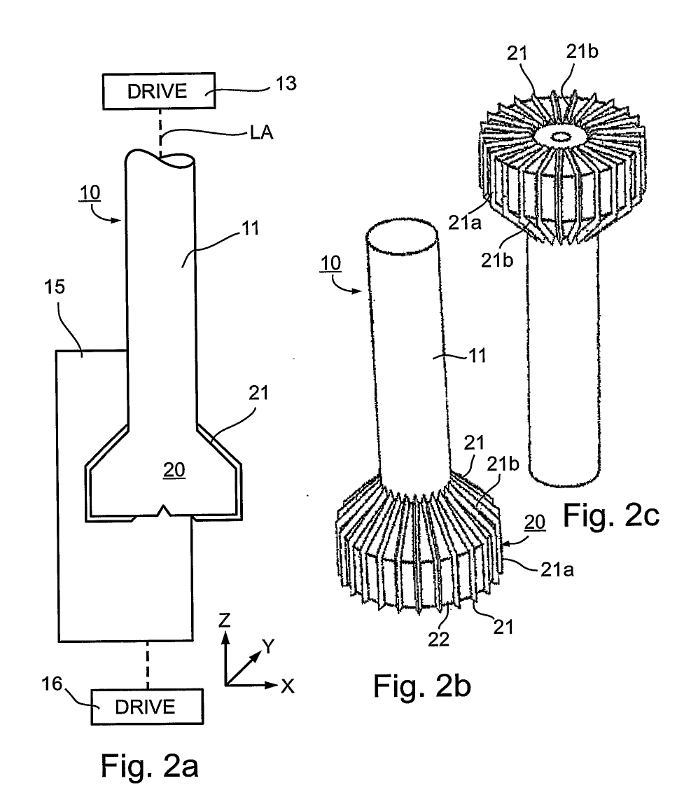

FIGS. 2-13 illustrate the invention embodied in a milling machine, wherein the drive system rotates the cutter tool about its longitudinal axis (the Z-axis), which is also the axis of the relatively short reciprocatory displacements. The cutter tool has cutting edges which become oriented, during each cutting stroke, to generate: (a) a lateral force tending to move the cutter tool in the lateral direction perpendicularly to the longitudinal axis of the cutter tool, and (b) an axial force in the cutter tool parallel to the longitudinal axis of the cutter tool, thereby imposing a substantial frictional resistance against movement of the cutter tool in the lateral direction. The reciprocatory displacements along the Z-axis also have the effect of avoiding overheating of the cutter tool (or the workpiece).

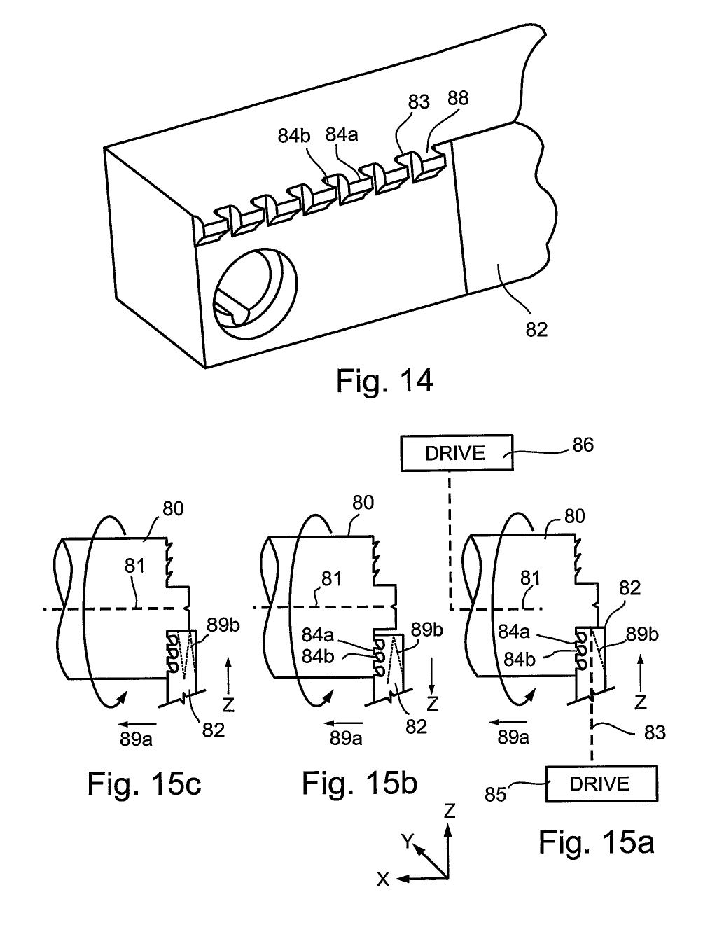

FIGS. 14-18 illustrate the invention embodied in a lath-type machine, wherein the drive system rotates the workpiece (as distinguished from its cutter tool) about its longitudinal axis (the X-axis), the cutter edges generating force (a) extend substantially parallel to the longitudinal axis of the cutter tool (the Y-axis); and the cutter edges generating force (b) extend substantially perpendicularly to the longitudinal axis of the cutter tool (the Z-axis).

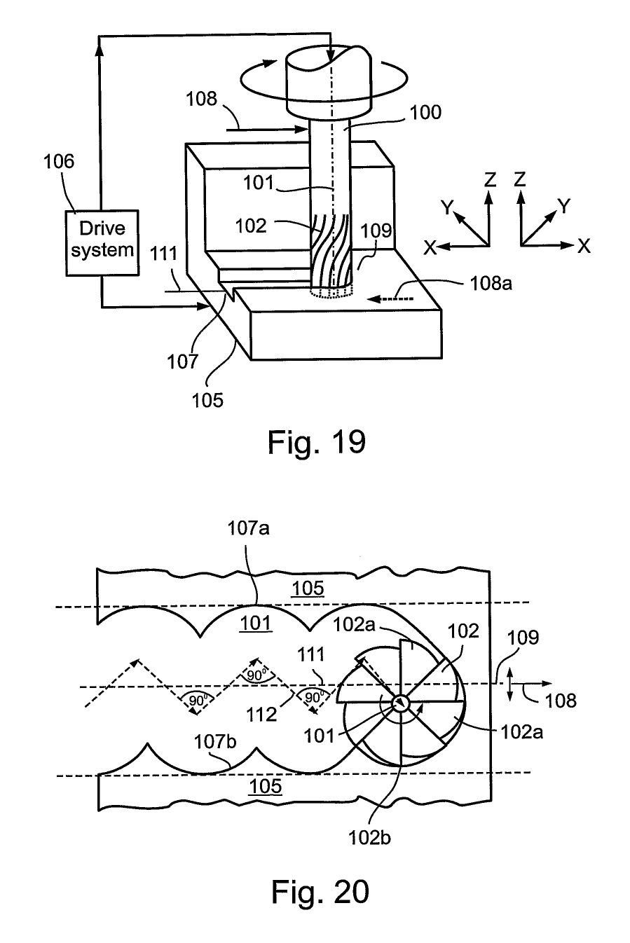

FIGS. 19-24 illustrate a further embodiment of the invention in a milling machine wherein the drive system rotates the cutter tool about its longitudinal axis (the Z-axis). In this embodiment, the second orthogonal axis of the relatively short reciprocatory displacements is the Y-axis (rather than the Z-axis); and the cutter tool has axially-extending cutter edges (along the Z-axis), such that in each of the relatively short reciprocatory displacements, the displacement in each direction causes the cutting edges on the leading side and only on one lateral side of the cutter tool to engage the workpiece, thereby substantially decreasing the lateral force applied to the cutter tool, and the heat generated by the cutter tool, and accordingly, enabling the rate of removal of material from the workpiece to be substantially increased.

The diagrams of FIGS. 25-30 illustrate various ways in which the drive system can be pre-programmed (e.g, in a NC cutter machine), to periodically interrupt the displacement of the cutter tool relative to the workpiece for a short period of time along one or more orthogonal axes in order to decrease the heating generated by the cutter tool, and thereby to enable operating the cutter tool at a higher speed without overheating.

### The Milling Machine Embodiment of FIGS. 2-10

FIG. 2a illustrates one form of cutter tool constructed in accordance with the present invention for use in a milling machine, whereas FIGS. 2b and 2c more particularly illustrate the cutter edges in the cutter tool of FIG. 2a.

Thus, as shown particularly in FIG. 2a, the cutter tool 10, which includes a shank 11 and cutter head 12, is driven by a drive 13 to rotate about its longitudinal axis LA (the Z-axis in the illustrated diagram), which drive may also be used for moving the cutter tool along the Z axis. Cutter head 12 has a plurality of cutter edges, as will be described more particularly below, engageable with the workpiece 15 for removing portions of the workpiece during a cutting operation. Workpiece 15 is driven by a drive 16 along the X axis. the Y axis, and/or the Z axis, to select the portions of the workpiece to be removed during a cutting operation.

The cutter head 12 is schematically illustrated in FIGS. 2a-2c, as being in the form of an annular ring 20 of larger diameter than the shank 11. Ring 20 is integrally formed with a plurality of radially-extending cutter blades 21 alternating with smaller diameter slots or spaces 22, dividing the ring into a plurality of cutter sectors. Each cutter blade 21 includes an axially-extending edge 21a projecting outwardly of the spaces 22, such that the cutter head 12 defines a plurality of axially-extending cutter edges 21 a spaced circumferentially of the cutter head. Each cutter blade 21 further includes a radially-extending cutter edge projecting outwardly of the spaces 22 on their opposite sides, such that the cutter blades also define a plurality of radially-extending cutter edges 21b on each of the opposite sides of the cutter head. As seen in FIG. 2b, the upper radial cutter edges 21b are also angled upwardly along the Z-axis; whereas the lower cutter edges, seen in FIG. 2c, are perpendicular to the Z-axis.

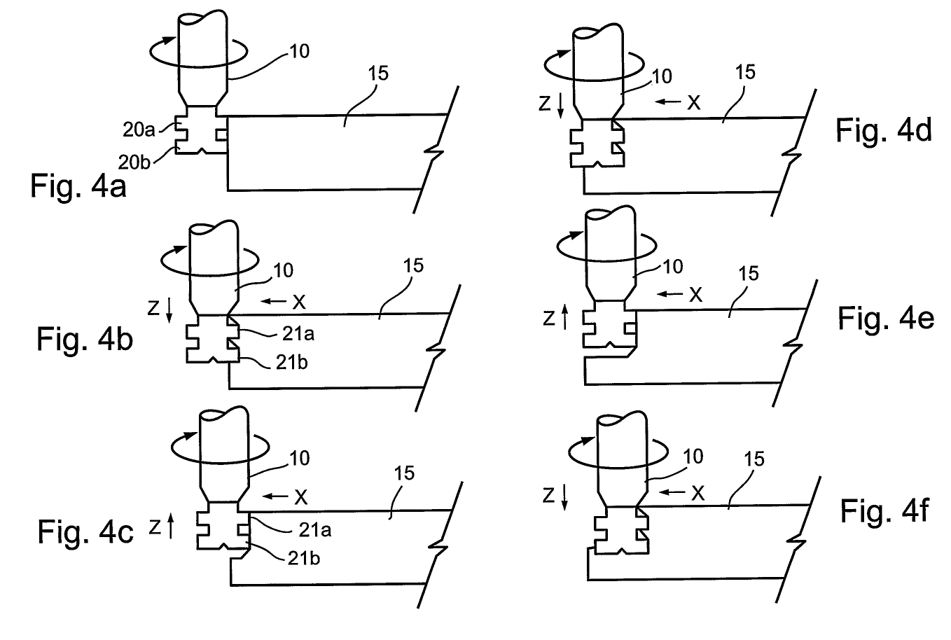

As will be described below, particularly with respect to FIG. 4, when cutter tool 10 is used in a milling machine, the drive system of the milling machine (e.g., an NC milling machine) is programmed to produce a relatively long unidirectional displacement between the cutter tool and workpiece along a first orthogonal axis (the X-axis in this case), and a plurality of relatively short reciprocatory displacements between the cutter tool and workpiece along a second orthogonal axis (the Z-axis in this case), which is the longitudinal axis of the cutter tool.

In this embodiment, the axially-extending cutter edges 21 a become oriented, during each cutting stroke, to generate a lateral force tending to move the cutter tool in the lateral direction perpendicularly to the longitudinal axis of the cutter tool; and the radially-extending cutter edges 21b become oriented, during each cutting stroke, to produce an axial force in the cutter tool imposing a substantial frictional resistance against movement of the cutter tool in the lateral direction.

This interplay of forces produced during the use of the cutter tool in a milling machine operation increases the capability of the cutter tool to sustain the loads applied by the workpiece to the cutter tool, and thereby enables the cutter tool to be used for removing material from the workpiece at a more rapid rate.

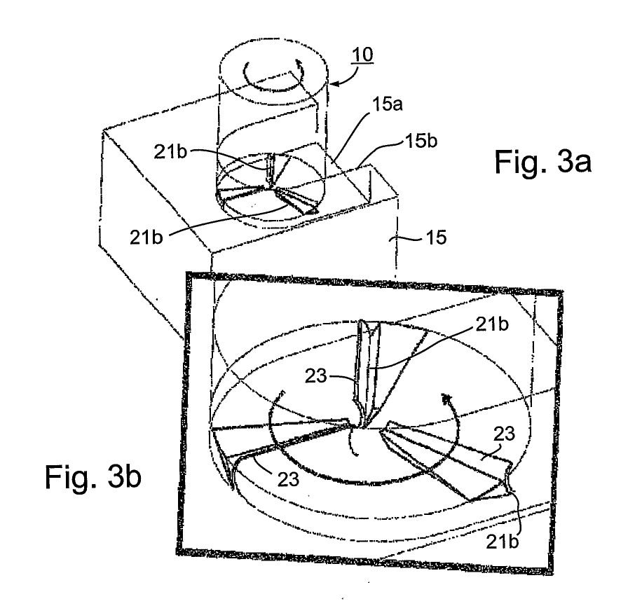

FIGS. 3a and 3b diagrammatically illustrate how the radially-extending cutter edges 21b, projecting from the underside of annular ring 20, produce an axial force against the cutter tool imposing a substantial frictional resistance against movement of the cutter tool in the lateral direction. For simplification purposes, the diagrams of FIGS. 3a and 3b illustrate only three such radially-extending cutter edges 21b.

As shown in FIG. 3a, the cutter tool 10 is rotated in the direction of the arrow, and engages the workpiece 15 while relative movement is effected during the relatively short reciprocatory displacements of the workpiece relative to the cutter tool. In such a case, each of the radially-extending cutter edges 21b will produce a shaving 23 in the engaged portion 15a of the workpiece 15 resulting in the slot 15b being formed at one side of the cutter tool. The formation of each of the shavings 23 will produce two forces applied to the cutter tool, namely a rotary force opposing the rotation of the cutter tool, and an axial force pressing the cutter tool more firmly against the workpiece surface 15a. The latter force, namely that pressing the cutter tool firmly against surface 15a of workpiece 15, imposes a substantial frictional resistance against movement of the cutter tool in the lateral direction (rightwardly in FIG. 3a). Accordingly, the cutter tool is more firmly held within the workpiece, and is therefore better able to withstand larger loads than would be possible in the prior art conventional construction illustrated in FIG. 1a.

A cutter tool constructed as described above is therefore not limited to a penetration depth (of about 0.4 times its diameter as described above with respect to FIG. 1a), and may therefore have a penetration depth substantially larger than 0.4 times its diameter. Accordingly, a cutter tool constructed as described above is capable of withstanding larger loads during cutting operations, and thereby permits cutting operations to be performed at a more rapid rate.

FIG. 4 illustrates a cutting operation of the cutter tool 10 which, in this case, is shown as having two annular cutter rings 20a, 20b, axially spaced from each other, with each ring being divided into a plurality of sectors by a plurality of radially-extending cutter blades (21, as described above with respect to FIGS. 2a-3b). Position A illustrates the starting position of the workpiece 15 with respect to the cutter tool 10 at the beginning of the respective cutter stroke. The remaining positions B-F illustrate the displacement paths traversed by the workpiece with respect to the cutter tool during the subsequent reciprocations along the Z-axis, during the unidirectional displacement along the X-axis. It will thus be seen that, during each cutter stroke, a relatively long unidirectional displacement is effected between the cutter tool and workpiece along the X-axis, and a plurality of relatively short reciprocatory displacements are effected between the cutter tool and workpiece along the Z-axis.

While FIG. 4 illustrates both the workpiece 14 and the cutter tool 10 being displaced, it will be appreciated that the cutter tool 10 could also be displaced horizontally (along the X-axis) when moving through the illustrated paths.

As described above, each vertical (Z-axis) component of relative movement between the workpiece and the cutter tool produces an axial force against the engaged surface of the workpiece pressing the cutter tool firmly against the workpiece, thereby increasing the resistance of the cutter tool to bending, fracture, or vibration even against relatively high lateral loads.

Thus, as shown in FIG. 4, when the cutter tool 10 is moved from position A to position B, the axial cutter edges 21a engage the workpiece to produce the lateral force, whereas the lower radial cutter edges 21b engage the workpiece to produce the axial force, while the upper radial cutter edges 21b are spaced from the workpiece. On the other hand, when the cutter tool is moved from position B to position C, the upper radial cutter edges 21b engage the workpiece to produce the axial, while the lower cutter edges 21b do not engage the workpiece. It will be seen, accordingly, that during each reciprocation of the cutter tool along the Z-axis, only one of the two radial cutter edges will engage the workpiece, allowing the other radial cutter edge to dissipate heat, thereby enabling the cutter tool 10 to be rotated at a higher speed without danger of overheating. The latter aspect of the invention will be more particularly described below with respect to FIGS. 25-30.

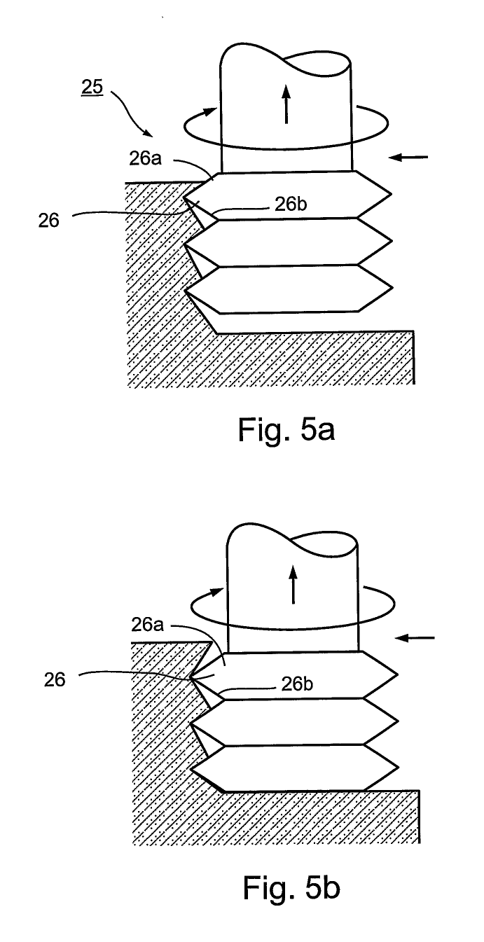

FIGS. 5a and 5b illustrate a modification in the construction of the cutter head, therein generally designated 25. In this modification, the cutter head 25 is formed with a plurality of cutter rings 26 having an upper cutter edge 26a extending radially but slanted towards the longitudinal axis of the cutter head, and a lower cutting edge 26b also extending radially but slanted in the opposite direction to the longitudinal axis of the cutter head.

FIG. 5a illustrates the upper movement of the cutter head during a reciprocation, wherein it will be seen that the upper cutting edges 26a engage the workpiece, while the lower cutter edges 26b do not engage the workpiece. FIG. 5b illustrates a downward stroke, wherein it will be seen that the lower cutting edges 26b engage the workpiece, while the cutting edges 26a do not engage the workpiece. In this case, the axial component of each cutting edge 26am 26b generates the lateral force applied to the cutter tool, whereas the radial component of each cutter edge 26a, 26b generates the axial component applied to the cutter tool to impose a substantial frictional resistance against movement of the cutter tool in the lateral direction. It will also be seen that during each reciprocation of the cutter tool, a part of the cutting edges will engage the workpiece generating heat, whereas another part of the cutter edges will not engage the workpiece and therefore will be effective to dissipate heat, thereby permitting higher speed rotation of the cutter tool without the danger of overheating.

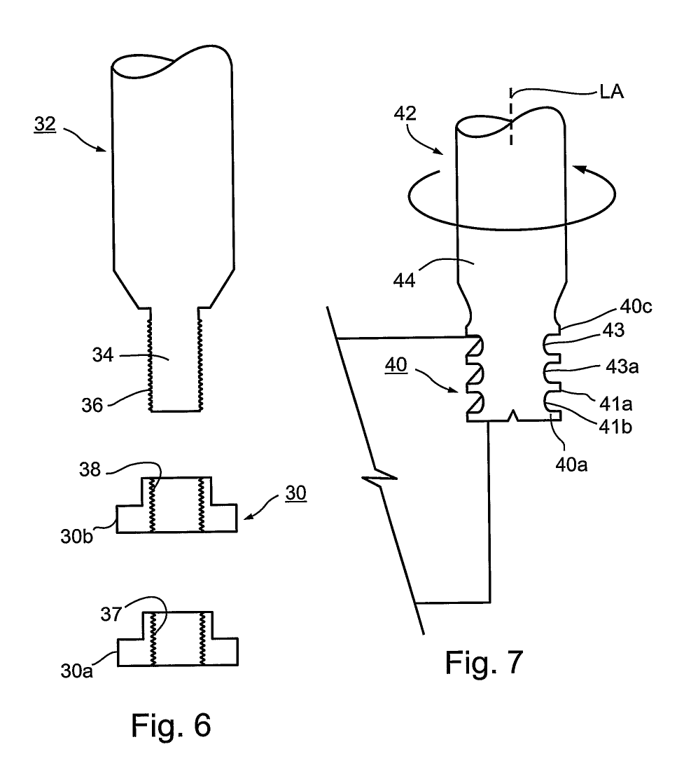

FIG. 6 illustrates a variation, wherein the cutter head 30 of the cutter tool 32 is provided with detachable cutter rings 30a, 30b, to permit each cutter ring to be individually sharpened, repaired or replaced, as desired. In this example, the cutter tool 32 is provided with a shank 34 having external threads 36 for receiving the internal threads 37, 38, formed in the two cutter rings 30a, 30b, respectively.

FIG. 7 illustrates a further variation wherein the cutter head 40 of the cutter tool 42 is provided with a larger number of rings 40a-40d each integrally with the shank 44 of the cutter tool. The cutter rings 40a-40e are axially spaced from each other to define spaces 43 between them for accommodating the cuttings produced during the cutting operation. As shown in FIG. 7, the inner surface 43a of space 43 is of concave configuration. In addition, the axially-extending cutter edge 41a of each cutter ring extends substantially parallel to the longitudinal axis LA of the cutter tool, and the radially-extending cutter edge 41b of each cutter ring extends substantially perpendicularly to the longitudinal axis LA of the cutter tool. Accordingly, and as described above, the forces generated by the radially-extending cutter edges 41b will be axial forces substantially parallel to the longitudinal axis LA of the cutter tool pressing the cutter tool firmly against the workpiece, and thereby increasing its resistance to lateral forces produced by the cutter edges 41a.

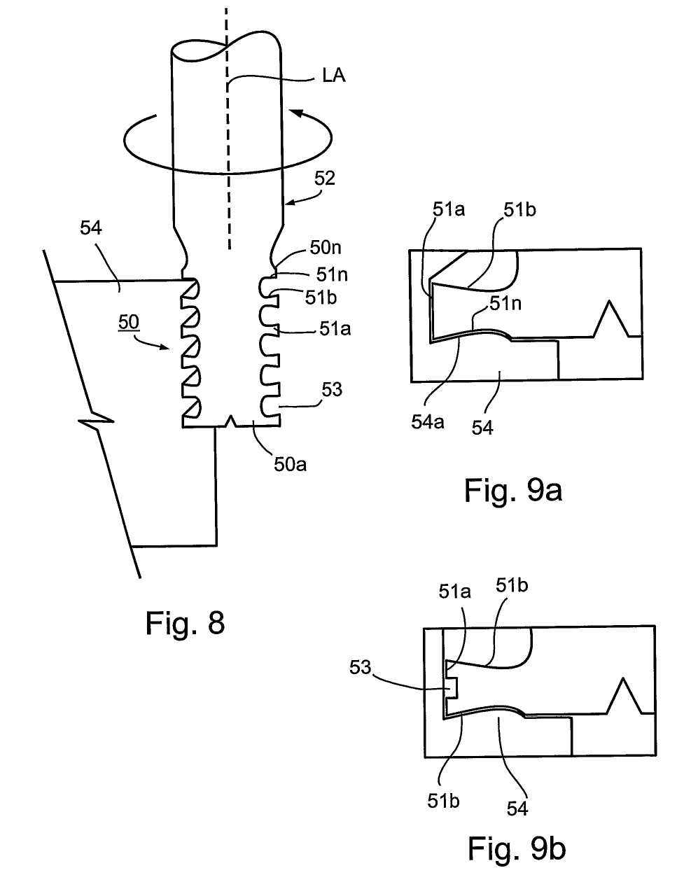

FIG. 8 illustrates an important modification wherein the cutter head 50 of the cutter tool 52 is also formed with a plurality of cutter rings, 50a-50n, but in this case the radially-extending cutter edges 51b on the opposite sides of each cutter ring converge slightly towards the longitudinal axis LA of the cutter tool. As schematically shown in FIG. 9a, such cutter edges 51b thus produce a sloping surface, shown at 541, in the workpiece 54, which sloping surface further increases the frictional resistance against movement of the cutter tool in the lateral direction by the lateral forces produced by the axially-extending cutter edges 51a.

FIG. 9b illustrates another modification in the construction of the cutter tool, wherein each of the axially-extending cutter edges 51a is formed with a small cut-out 53 to decrease the effective length of cutter edge 51a, and thereby the lateral force produced by that edge during a cutting operation. Preferably, each cut-out 53 is about one-third the length of its respective cutter edge 51a, and is located centrally thereof, so as to effectively decrease the length of the cutter edge by one-third.

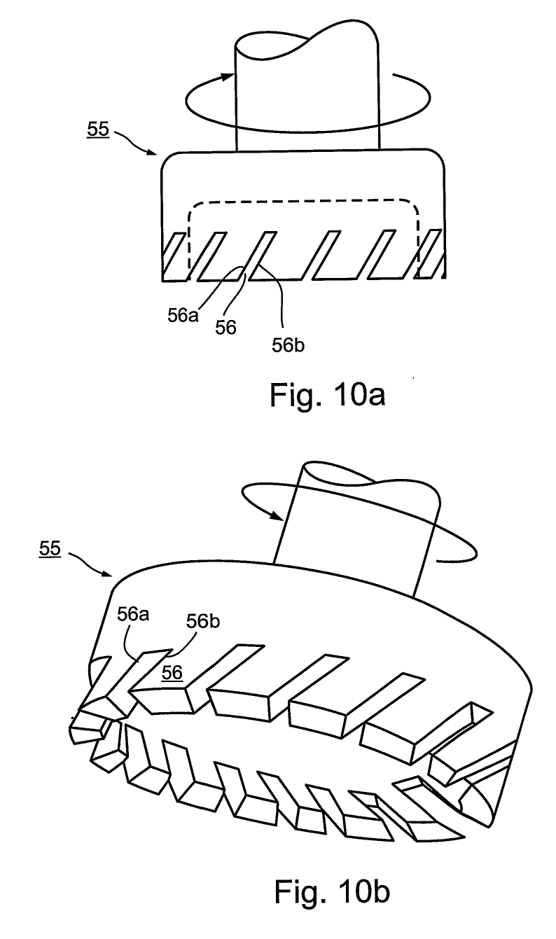

FIGS. 10a and 10b illustrate another cutter heat, generally designated 55, having an open lower end formed with a plurality of cutter segment 56 each having a cutter edge 56a on one side, which serves as the leading cutter edge in the illustrated direction of rotation, and a cutter edge 56b on the opposite side, which serves as the tracking cutter edge in the illustrated direction of rotation. Both types of cutter edges 56a, 56b are slanted with respect to the longitudinal axis (Z-axis) of the cutter tool so as to have an axial component parallel to the Z-axis, and a radial component perpendicular to the Z-axis. Such a cutter head thus is similar to the cutter head described above with respect to FIGS. 5a and 5b, and would produce a similar cutting operation.

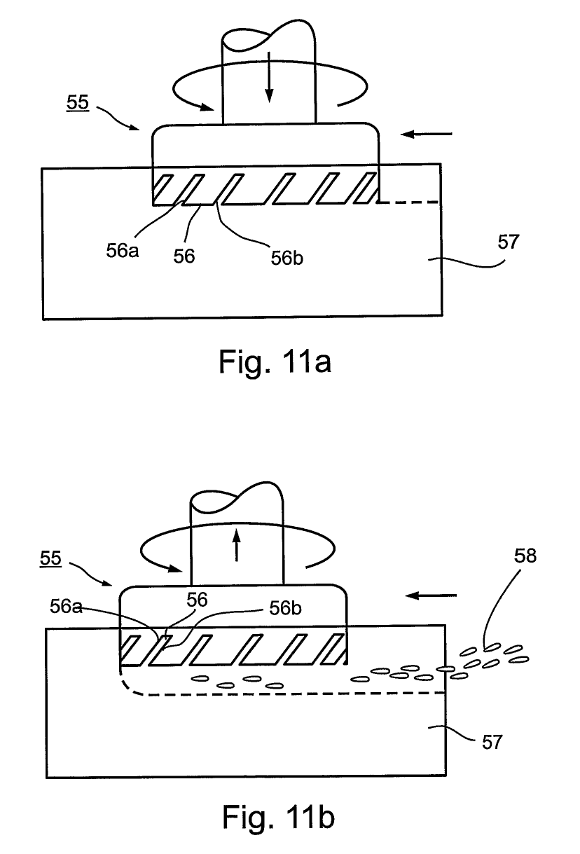

FIG. 11a illustrates the downward stroke of the cutter head 55 during each reciprocation, wherein it will be seen that cutter edges 56a engage and remove the material from the workpiece 57; whereas FIG. 11b illustrates the upward stroke of each reciprocation, wherein cutter edges 57b engage the workpiece. As also shown in FIG. 11b, since the cutter head moves out of contact with the workpiece, a space is provided for the ejection of the shavings 58 produced during the cutting operation.

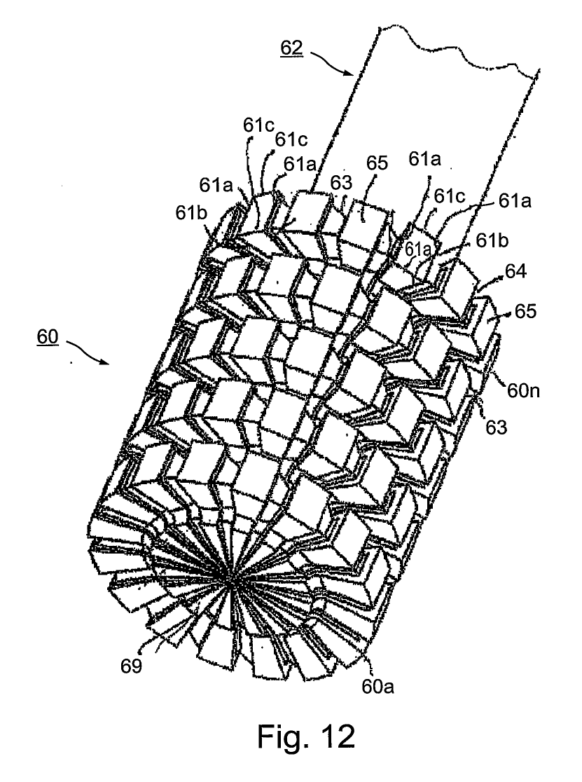

FIG. 12 illustrates a further cutter head 60 in a cutter tool 62 formed with a plurality of annular cutter rings 60a-60n axially spaced from each other by spaces 63, with each ring being formed with spaces 64 to divide the ring into a plurality of cutter sectors 65. Each cutter sector 65 is thus defined by a pair of axially-extending cutter edges 61a on two of its opposite sides, and by a pair of radially-extending cutter edges 61b on two other of its opposite sides. In this case, each cutter sector 65 further includes a pair of circumferentially-extending cutter edges 61c on the remaining two of its opposite sides. The thickness of each sector tapers inwardly towards the longitudinal axis of the cutter tool, as shown at 51b in FIGS. 8 and 9a, so as to produce, in addition to the axial component of force tending to press the cutter tool, also the slope 15c illustrated in FIGS. 9a and 9b producing further resistance against movement of the cutter tool in the lateral direction.

It will be seen that, in FIG. 12, the inner end of the cutter tool 62 is also formed with a plurality of triangular-shaped sectors 69 extending radially towards the longitudinal axis of the cutter tool but of smaller diameter than the cutter sectors 65. The smaller diameter of sectors 69 enables the cutter tool to accommodate and eject the shavings produced by the smaller diameter sectors 69.

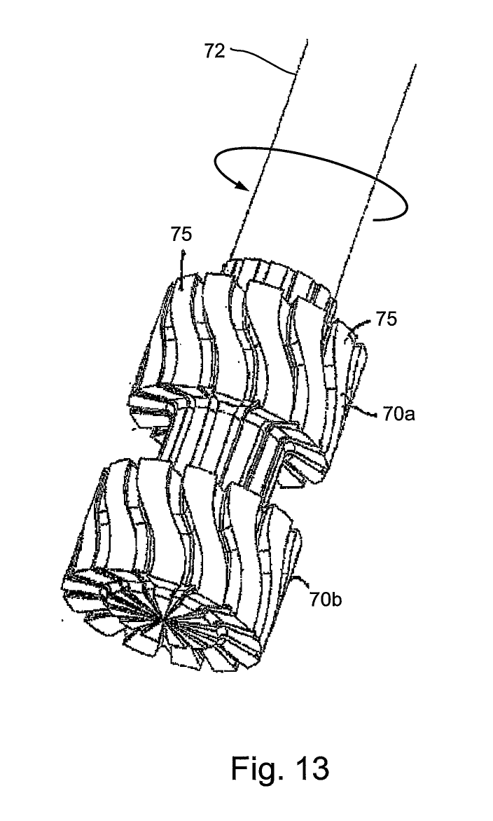

In the construction illustrated in FIG. 12, the cutter sectors 65 of the cutter rings 60a-60n are in axial alignment with each other. FIG. 13 illustrates a variation wherein the cutter sectors, therein designated 75, are arrayed according to a helical array. Such a helical array of cutter sectors better accommodates the shavings in the spaces between the cutter sectors during each cutting stroke.

In FIG. 13, it will be noted the cutter tool 72 includes, for purposes of example only, two annular rings 70a, 70b, of cutter sectors 75, but each is of a longer length than in the cutter tool illustrated in FIG. 12. FIG. 20, described below, illustrates another construction of cutter head that may be used.

The Lathe-Type Machine Embodiment (FIGS. 14-18b)

FIGS. 14-18b illustrate the invention implemented in a lathe-type machine, in which a workpiece 80 (FIGS. 15a-15c) is rotated about its longitudinal axis 81, while a cutter tool 82, having a longitudinal axis 83, and cutter edges 84 is periodically reciprocated with respect to the workpiece 80 during each cutting stroke to remove portions of the workpiece as required for the particular cutting operation performed. As distinguished from the milling machine embodiment described above with respect to FIGS. 2-13, the lathe-type machine illustrated in FIGS. 14-18b includes a cutter tool drive 85 for reciprocating the cutter tool, and a workpiece drive 86 for rotating the workpiece relative to the cutter tool.

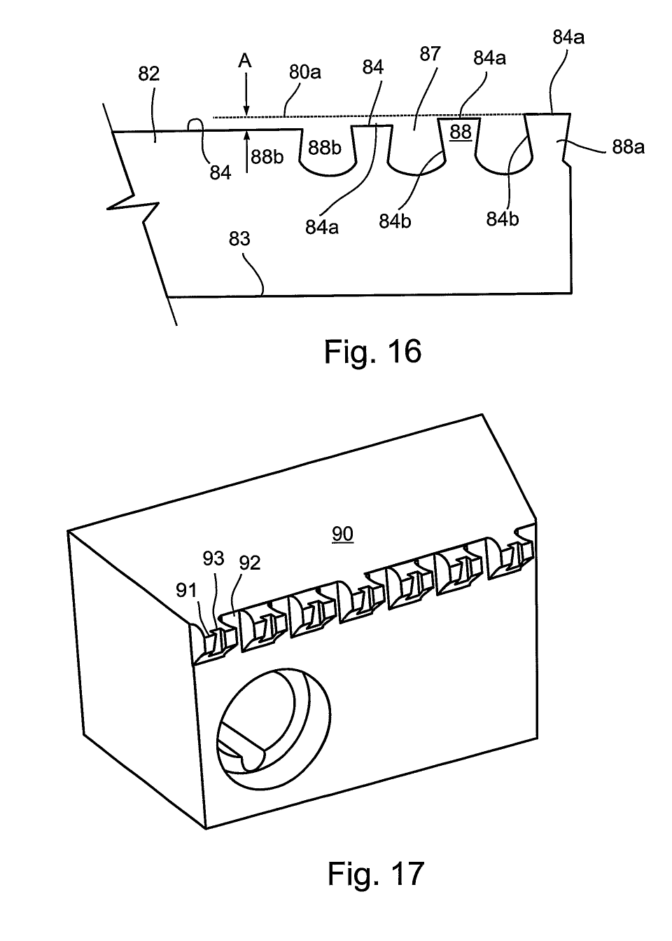

As shown particularly in FIG. 16, cutter edge 84 of cutter tool 82 is not continuous, but rather is interrupted by recesses or cut-outs 87, each of the configuration of the recesses or cut-outs 53 in the milling machine cutter tool illustrated in FIG. 8. The cutter edge 84 of cutter tool 82 is thus divided into a plurality of cutter segments 88, separated from each other by a cut-out 87. Each cutter segment 88 includes a cutter edge 84a extending substantially parallel to the longitudinal axis 83 of the cutter tool 82, and two cutter edges 84b, 84c extending somewhat perpendicularly to the longitudinal axis 83 of cutter tool 82 but tapered inwardly towards each other in the direction of the longitudinal axis LA of the cutter tool.

Arrow 89a in FIGS. 15a-15c indicates the relatively long individual displacement between the cutter tool and the workpiece during each cutter stroke; whereas the broken lines 89b indicate the relatively short reciprocatory displacements of the cutter tool relative to the workpiece during the cutting stroke. Thus, during a cutting operation, the workpiece is rotated about its longitudinal axis 81, while the cutter tool 82 is reciprocated back and forth towards and away from the longitudinal axis 81 of the workpiece 80 (along the Y-axis) as indicated by broken-line arrows 89b, as the cutter tool is moved through a relatively long unidirectional displacement path (along the X-axis) parallel to axis 81 in the direction of arrow 89a.

As described above with respect to FIG. 8, and also FIGS. 3a and 3b, such a reciprocatory displacement of the cutter tool presses the cutter tool firmly against the workpiece, so as to increase its capability of withstanding large lateral forces produced by the workpiece during the cutting operations.

FIG. 16 illustrates a further preferred feature in the cutter tool 82. Thus, as shown in FIG. 16, cutter edge 84 of the cutter tool is not precisely parallel to the surface 80a of the workpiece 80 to be cut, but rather diverges slightly outwardly at its distal cutter segment 88a as shown by the dimension “A” at its cutter segment 88b. Accordingly, when the cutter edge 84 is first brought into contact with the workpiece, its projecting distal segment 88a first contacts the workpiece, whereupon further pressure applied to the cutter tool slightly deforms the cutter edge 84 so as to produce a more complete and uniform line contact between the cutter edge and the workpiece during the cutting operation.

FIG. 17 illustrates another modification in the cutter tool, therein designated 90, similar to the modification illustrated in FIG. 9b with respect to a cutter tool constructed for use in a milling machine. Thus, as shown in FIG. 17, the cutter edge, generally designated 91, is formed with a plurality of slots or cut-outs of two types. These include a first group of slots 92 extending a relatively large distance towards the longitudinal axis of the cutter tool; slots 92 generally correspond to slots 52 in FIG. 9b. Slots 92 alternate with a second group of slots 93 extending a relatively short distance towards the longitudinal axis of the cutter tool, which latter slots generally correspond to slots 53 in FIG. 9b. The provision of the second group of slots 93 thus reduces the effective length of the cutter edges 91a, which thereby reduces the lateral force applied to the cutter tool at the beginning of each stroke during a cutting operation as described above.

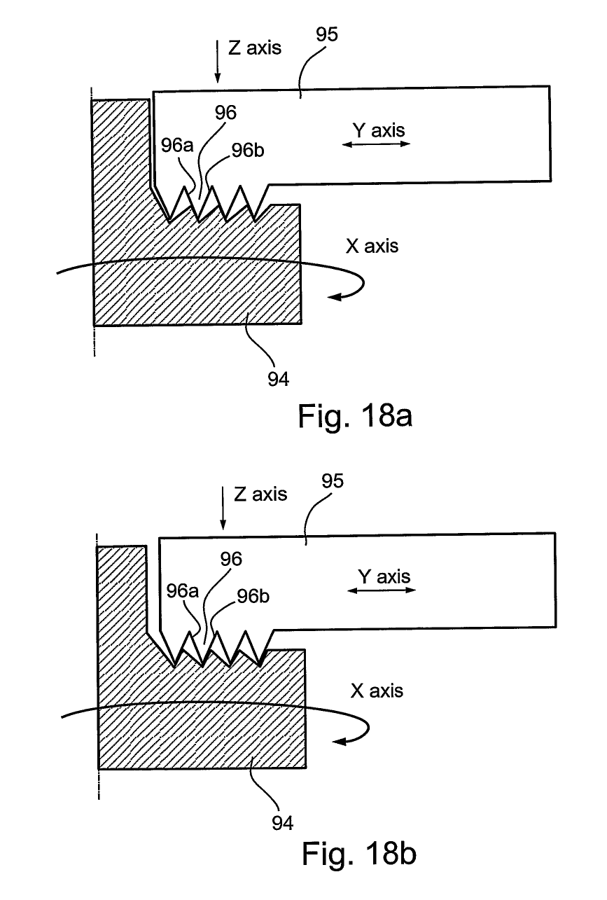

FIGS. 18a and 18b illustrate another cutter tool constructed for use with a lathe-type machine, in which the workpiece 94 rotates about the X-axis, and the cutter head 95 is reciprocated about the Y-axis, while the relatively long unidirectional displacement between the cutter tool and workpiece is along the Z-axis. The cutter head 95 illustrated in FIGS. 18a and 18b includes cutter segments 96 having cutter edges 96a, 96b on its opposite sides at an angle so as to produce X-axis and Z-axis components of forces against the cutter tool. As described above particularly with respect to FIGS. 5a, 5b and 10a, 10b, the cutter edges 96a on one side of each cutter segment 96 engage the workpiece during the forward stroke (FIG. 18a), while the cutter edges on the opposite side of the respective cutter segment do not engage the workpiece and therefore are free to dissipate heat; whereas in the opposite stroke, the opposite occurs. Accordingly, such a construction is not only able to avoid unduly straining the cutter tool, but also of unduly heating the cutter tool, when the cutting operation is effected at relatively high speed.

### The Milling Machine Embodiments of FIGS. 19-24

FIGS. 19-24 illustrate further milling machine embodiments of the invention, similar to those of FIGS. 2-13, with the following main exception: whereas in FIGS. 2-13 the axis (therein referred to as the second orthogonal axis) of the relatively short reciprocatory displacements is parallel to the longitudinal axis of the cutter tool (that is, the Z-axis in FIG. 2a), in the embodiments of FIGS. 19-24, this second orthogonal axis of the relatively short reciprocatory displacements, is perpendicular to the longitudinal axis of the cutter tool, (that is, the Y-axis in FIG. 2a). As will be described below, in the absence of such reciprocatory displacements (along the Y-axis) during each relatively long displacement between the cutter tool and the workpiece (along the X-axis), the cutter edges of the cutter tool will, at any instant, be loaded by the leading side of the cutter tool, and also by both lateral sides of the cutter tool. On the other hand, when these Y-axis, relatively short reciprocatory displacements are provided, the cutter edges of the cutter tool, at any particular instant, will be in contact with the leading side of the cutter tool but only with one of the lateral sides of the cutter tool. In such an arrangement, therefore, the load on the cutter tool, as well as the heat generated by the cutter tool, at any particularly instant is substantially reduced, thereby permitting faster rates of travel and rotation speed of the cutter tool, and thereby faster rates of removal of material from the workpiece. In addition, the slot cut by the cutter tool during its relatively long unidirectional displacement along the X-axis will be slightly widened, thereby further increasing the rate of removal of the material from the workpiece.

FIG. 19 schematically illustrates the cutter tool 100 having a longitudinal axis 101 and cutter edges 102 of the helically-arrayed type as illustrated for example in FIG. 13. The relative displacement between the cutter tool 100 and the workpiece 105 is controlled by the drive system 106 to produce the slot 107. Arrow 108 illustrates the relatively long unidirectional displacement along the X-axis of the cutter tool 100 with respect to the workpiece 105 during each cutting stroke, and arrow 109 illustrates the relatively short reciprocatory displacements between the two during each cutting stroke along the Y-axis; that is, the direction of the relatively short reciprocatory displacements indicated by arrow 109 is perpendicular to both the longitudinal axis 101 (the Z-axis) of the cutter tool 100, and 111 (X-axis) of the slot 107 produced in the workpiece 105.

In FIG. 19, the broken-line arrow 108a indicates the lateral force applied to the cutting tool 100 by the workpiece during a conventional milling operation. This lateral force is amplified by the length of the cutter tool between the point of application of the unidirectional force indicated by arrow 108 and the force indicated by the broken-line arrow 108a. The force indicated by broken-line arrow 108a is multiplied by the distance to arrow 108, and thus imposes a serious limitation as to the permitted rate of travel of the cutter tool 100 with respect to the workpiece 105 along the relatively long unidirectional displacement path (the X-axis).

However, according to this implementation of the present invention, the force represented by broken-line 108a against the workpiece-engaged portion of the cutter tool 100 is substantially reduced by effecting, during each cutting stroke, relatively short reciprocatory displacements of the cutter tool 100 along the Y-axis, as indicated by arrow 109, during each unidirectional displacement indicated by arrow 108. In addition, such relatively short reciprocatory displacements along the Y-axis also increase the effective width of the slot 107 formed during each cutting stroke.

FIG. 20 more particularly illustrates the displacement of the cutter tool 100 with respect to the workpiece 105 during each cutting stroke, indicated by slot 107. It will be seen in FIG. 20, that the leading side 102a of the cutting edges 102 of the cutter tool will always be in contact with the workpiece 105 during the relatively long unidirectional displacement of the cutter tool with respect to the workpiece, which is along the X-axis, as shown by arrow 108. If the relatively short reciprocatory displacements (along the Y-axis as indicated by arrow 109) are not applied, the cutter edges on both lateral sides 102b and 102c of the cutter tool will also always be in contact with the workpiece at any particular instant. However, as shown in FIG. 20, when the relatively short reciprocatory displacements 109, are also produced, the cutter edges of only one of the two lateral sides will be in contact with the workpiece at any particular instant. In the instant represented by FIG. 20, the cutter edges of only the lateral side 102b will be in contact with the workpiece, and the cutter edges at the opposite lateral side 102c will be spaced from the workpiece. Accordingly, the relatively short reciprocatory displacements indicated by arrow 109 substantially reduces the load applied to the workpiece at any particular instant, thereby enabling the cutting operation to be speed up without unduly loading the cutting tool.

As also seen in FIG. 20, the slot 107 produced by the relatively short reciprocatory displacements will be defined by the curved lines 107a, 107b. Thus, slot 107 will be of larger width than if the reciprocatory displacements are not provided, thereby further contributing to the rate of removal of material from the workpiece. If the curved edges of the slots 107, as represented by lines 107a and 107b, are not desired in the finished product, the finishing cutting stroke of the cutter tool could omit the relatively short reciprocatory displacements, thereby producing an even finished surface.

While FIG. 19 illustrates the cutter tool 100 as being of the type including a helical array of cutter edges 102, as shown in FIG. 13, it will be appreciated that the cutter tool could be any of those described with respect to the FIGS. 2-13 embodiment of the invention.

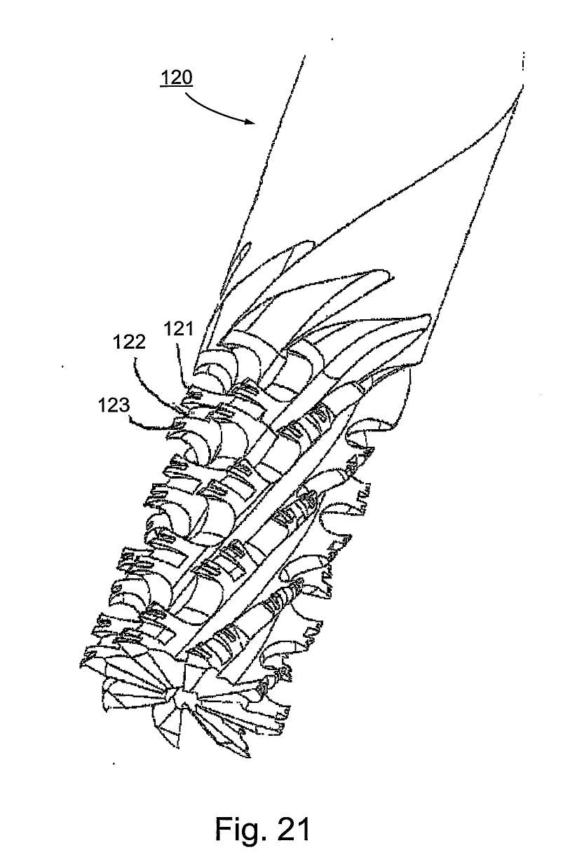

FIG. 21 illustrates a further construction of cutter tool, therein designated 120, particularly useful for any of the above-described milling machine embodiments of the invention. Cutter tool 120 illustrated in FIG. 21 includes the feature described above in FIG. 9b, and also in FIG. 17 with respect to the cutter tool 90 for a lathe-type machine.

Thus, the cutter tool 120 illustrated in FIG. 21, is formed with a plurality of helical arrays of cutter edges 121 defined by a plurality of relatively deep helical slots 122, and a plurality of relatively shallow helical slots 123. The advantages described above with respect to the cutter tools illustrated in FIG. 9b and in FIG. 17 would therefore also apply with respect to the cutter tool illustrated in FIG. 17. It will be appreciated that the cutter tool illustrated in FIG. 21 could also be used in any of the above-described embodiments of the invention.

As shown in FIG. 20, the relatively long unidirectional displacement and the relatively short reciprocatory displacements are such as to produce a displacement path constituted of short strokes at an angle of approximately 90° to each other. This is clear from FIG. 20, wherein the curved lines 107a, 107b defining the slot 107 produced by the cutter tool, has a larger width than the diameter of the cutter edges of the cutter tool. It will therefore be seen that the amount of material removed during each cutter stroke is also larger than in a conventional milling operation, thereby further increasing the rate of removal during each cutting stroke.

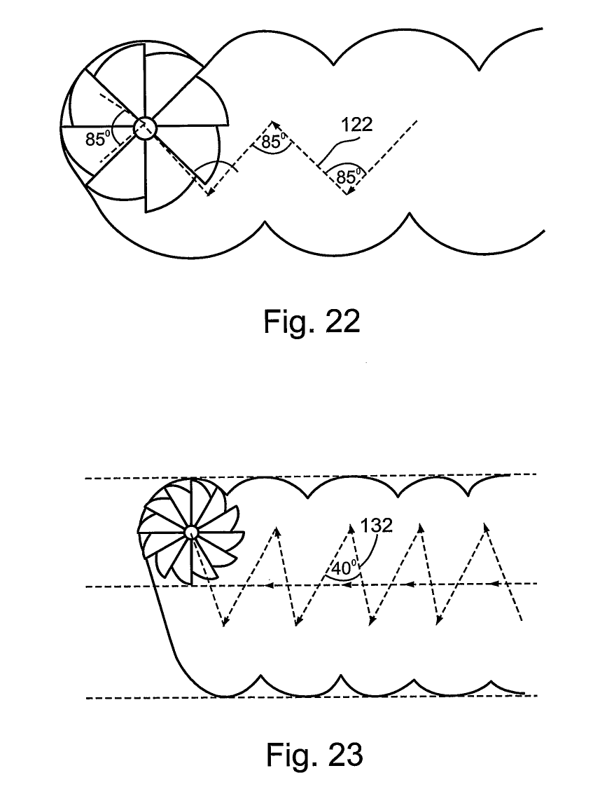

FIG. 22 illustrates a variation wherein the relatively long unidirectional displacement and the relatively short reciprocatory displacements are such as to produce a displacement path constituted of short strokes at an angle less than 90°, this being about 85° in the example illustrated in FIG. 18. Such a modification reduces the amount of material during each stroke, but enables the cutter stroke to be effected more rapidly.

FIG. 23 illustrates a modification wherein the relatively long unidirectional displacement and the relatively short reciprocatory displacements are such as to produce a displacement path constituted of short strokes at an angle much smaller than 90°, this angle being 40° in the example illustrated. Such a modification increases the amount of material reduced during each cutting stroke, but requires more time to execute a cutting stroke.

FIG. 24 illustrates a construction similar to that of FIG. 19, and therefore to facilitate understanding, the corresponding elements in FIG. 19 are identified by the same reference numerals in FIG. 24. The main difference in FIG. 24 over that of FIG. 19 is that the drive system 106 (e.g., controlled by an NC control system), during each cutting stroke, effects a plurality of relatively short reciprocatory displacements between the cutter tool and the workpiece not only along the Y-axis, as indicated by arrow 109, but also along the Z-axis as in the embodiments of FIGS. 2-13 and as indicated by arrow 110. Thus, the arrangement illustrated in FIG. 24 obtains the benefits described above with respect to FIGS. 2-13 in imposing a frictional resistance against the lateral force produced by the workpiece during a milling operation, and also the benefits described above with respect to FIGS. 19-23 in reducing the load applied to the cutter tool during a cutting operation.

### Further Variations to Prevent Overheating

As indicated above, a main purpose of the present invention is to permit higher speed removal of material from the workpiece while avoiding unduly straining the cutter tool or unduly heating the cutter tool or the workpiece. FIGS. 25-30 illustrate how overheating may be avoided by controlling the drive system (e.g., a NC control) to periodically interrupt the displacement of the cutter tool relative to the workpiece for short periods of time during each cutting stroke, along one or more orthogonal axes.

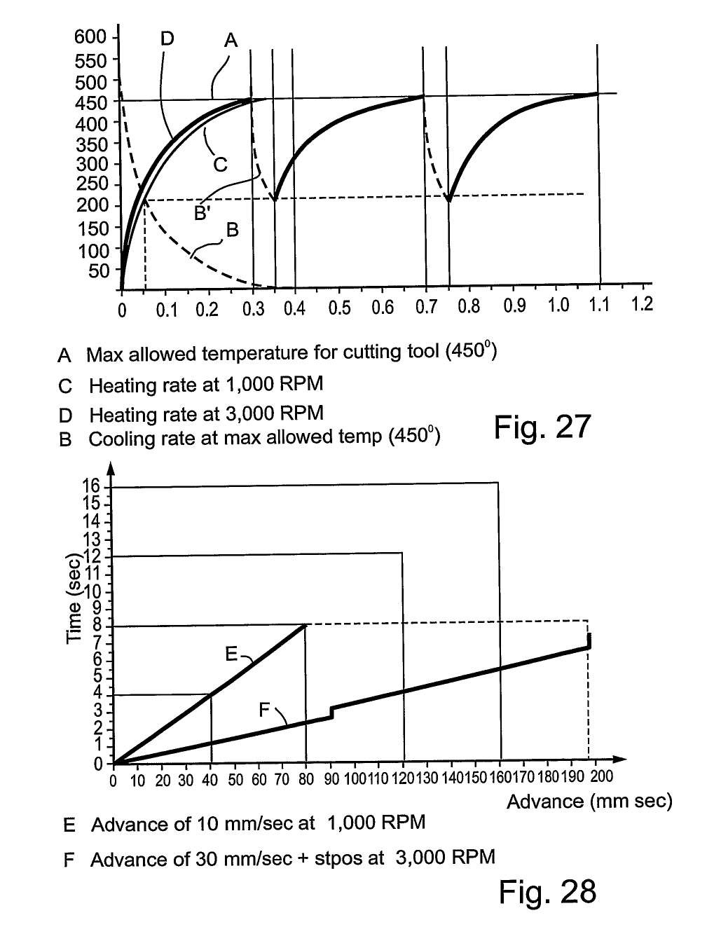

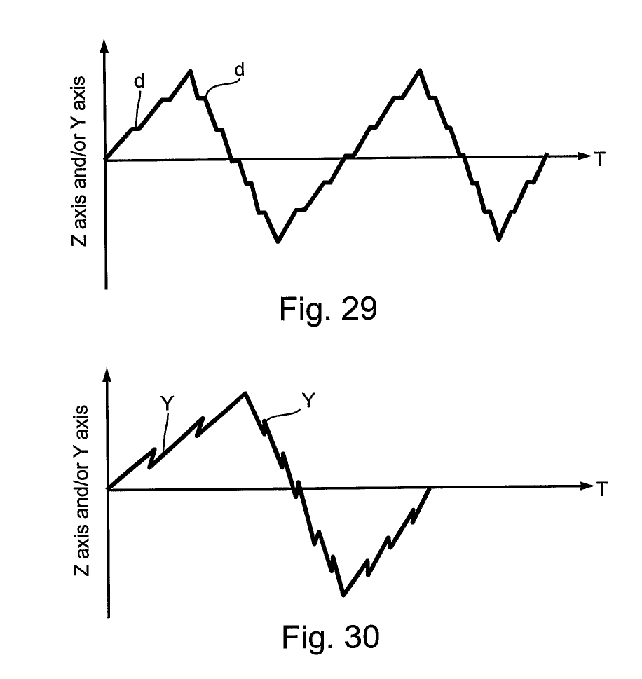

FIG. 25 illustrates a control that may be effected with respect to one of the above-described cutter tools used in a milling machine, wherein the drive system rotates the cutter tool about its longitudinal axis (the Z-axis), and produces a relatively long unidirectional displacement between the cutter tool and workpiece along the X-axis, and a plurality of relatively short reciprocatory displacements along the Z-axis. FIG. 25 illustrates the control wherein the displacement of the cutter tool relative to the workpiece is interrupted for a short dwell period (as shown at “d”) along the X-axis. As will be described more particularly below with respect to FIGS. 27 and 28, introducing such an interruption and short dwell period substantially reduces the possibility of overheating of the cutter tool, even though rotated at a relatively high velocity.

The diagram of FIG. 26 illustrates a similar operation, including periodic interruptions, except that instead of dwelling during each such interruption, the displacement is reversed (as shown at “r”), causing the cutter tool to disengage from the workpiece, and thereby permitting it to dissipate the heat at a faster rate, e.g., by natural radiation or by fluid cooling, before the displacement along the X-axis is resumed.

The foregoing is shown by the Temperature (degrees C.) vs. Time (seconds) diagrams of FIG. 27. Line A represents the maximum allowed temperature for the cutting tool, in this case 450° C. Curve B represents the heat-dissipation (cooling) rate at the Temperature of 450° C. It will be seen that the cooling rate is not linear, but rather exponential, being substantially higher at the higher temperatures and exponentially decreasing as the temperature decreases.

Curve C represents the heating rate of the cutter tool when operated at 1000 RPM, wherein it will be seen that the temperature increases exponentially at the beginning (e.g., the first three seconds), and remains the same thereafter when it approaches the maximum permitted temperature represented by line A (about 450 degrees C.), because of the high rate of heat dissipation at this high temperature.

As indicated above, when the drive system periodically interrupts the displacement of the cutter tool relative to the workpiece for a short period of time during its displacement along the X-axis, the high rate of heat dissipation during these interrupted intervals permits the machine tool to be operated at a substantially higher speed without overheating. This is shown by curve D, wherein it will be seen that driving the cutter tool at the higher speed (3000 RPM rather than 1000 RPM of curve C), causes the temperature of the cutter tool to rise to its maximum (line A) faster, (in this case about 3 seconds), but if it is interrupted for a short interval (in this case 0.5 seconds), the high rate of heat dissipation (represented by the broken-line D in FIG. 27), swiftly produces a drop in temperature (to about 225° C. in the illustrated example), before the displacement along the X-axis is resumed.

The interval of the interruption should be relatively short before the displacement is resumed. Preferably, it should be between one tenth and one-half the time for the displacement along the X-axis. In the example illustrated in FIG. 27, the displacement along the X-axis occurs for 0.03 seconds, and the interruption occurs for 0.005 seconds, before the displacement is resumed along the X-axis.

It will thus be seen that, as shown in FIG. 27, by introducing the interruptions as described above, the cutter tool may be operated at a substantially increased speed (3000 RPM rather than 1000 RPM) without unduly heating the cutter tool (or the workpiece).

The Time (seconds) versus displacement (nm/sec) diagram of FIG. 28 illustrates how this interruption feature, which enables the cutter tool to be rotated at a faster speed (3000 RPM vs 1000 RPM) produces a substantially faster rate of material removal from the workpiece. In FIG. 28, line E represents the rate of displacement of the cutter tool when driven at 1000 RPM, wherein it will be seen that it is displaced at a rate of 10 mm/sec, or 80 nm during the 8 second interval. On the other hand, line F represents the rate of displacement of the cutter tool when rotated at 3000 RPM, wherein it will be seen that, at this higher speed, it can be displaced 30 mm/sec, or approximately 240 mm in 8 seconds.

While the diagrams of FIGS. 27 and 28 are characteristic of the operation illustrated in FIG. 25, wherein each interruption involves a dwell (d), the results are similar in the operation illustrated in FIG. 26, wherein each interruption involves a short reversal (r), although the rate of cooling of the cutter tool during its normal operation, and during its interruption, will depend on the method of cooling used, e.g., radiation, cooling fluid, etc.

The diagrams of FIGS. 25-28 thus illustrate the advantages of introducing the interruptions during the relatively long unidirectional displacement between the cutter tool and workpiece (along the X-axis, in the milling machine applications described above). Similar advantages are obtainable when the interruptions are introduced in the reciprocatory displacements along the Z-axis as described above with respect to FIGS. 2-14, or along the Y-axis, as described above with respect to FIGS. 15-24. FIG. 29 corresponds to that of FIG. 25, wherein each short interruption involves a short dwell. (d), whereas FIG. 30 corresponds to that of FIG. 26, wherein each short interruption involves a reversal (r) before the displacement is resumed along the respective axis.

It will be appreciated that similar advantages are provided by operating the cutter tool in a lathe machine, as described above with respect to FIGS. 14-18b, wherein the relatively long unidirectional displacements between the cutter tool and workpiece are interrupted along the respective orthogonal axis, and/or the plurality of relatively short reciprocatory displacements are periodically interrupted along the respective axis. It will also be appreciated that any of the above-described modes of operation of the cutter apparatus can be easily pre-programmed in an NC (numerical control) machine.

It will thus be seen that the cutter apparatus and method of cutting described above permit a more rapid rate of material removal from the workpiece, thereby shortening the machine time. In most applications, the relatively-long displacements between the cutter tool and workpiece would be measured in centimeters and in seconds; for example, in most applications such relatively long unidirectional displacements would be at least 5 cm, e.g., 10-20 cm, and would take at least 5 seconds, e.g., 10-20 seconds. On the other hand, the relatively short reciprocatory displacements would usually be measured in millimeters and in fractions of a second. It will be appreciated that using such interruptions exploits the high rate of heat dissipation at the high temperature to enable driving the cutter tool (or the workpiece) at a higher speed. Thus, the more frequent the interruptions, the higher the speed the cutter tool can be driven without overheating.

It is also appreciated that programming the drive as may be desired for any particular cutter machine, or application of the cutter machine can be easily done by existing NC (numerical control) machines.

While the invention has been described with respect to several preferred embodiments, it will be appreciated that these are set forth merely for purposes of example, and that many other variations and applications of the invention may be made. For example, the relatively short reciprocatory displacements between the workpiece relative to the cutter tool could include an oscillation of the cutter tool, rather than a reciprocation of the cutter tool. Also, while the displacement paths illustrated at 112 (FIG. 20), 122 (FIG. 22) and 132 (FIG. 23), are straight line paths, there could be other displacement paths, such as cycloidal or other curvilinear paths. In addition, the cutting operation could include relatively slow cutting strokes as described above, and fast return strokes not involving a cutting operation. This invention may also be used for cutting any materials, such as metal, wood, plastic, stone, etc.

Many other variations, modifications and applications of the invention will be apparent.

1.-75. (canceled)

76. A method of cutting a workpiece having a longitudinal axis comprising cutting the workpiece with a cutter tool, having a longitudinal axis, in one or more cutting strokes, each cutting stroke comprising:
(a) a relatively long unidirectional displacement between the cutter tool and workpiece along a first orthogonal axis; and
(b) a plurality of relatively short reciprocatory displacements between the cutter tool and workpiece along a second orthogonal axis perpendicular to the first orthogonal axis.

77. The method of cutting according to claim 76, wherein the cutter tool is rotated about its longitudinal axis during a cutting operation.

78. The method of cutting according to claim 77, wherein the second orthogonal axis of the relatively short reciprocatory displacements is parallel to the longitudinal axis of the cutter tool.

79. The method of cutting according to claim 77, wherein the second orthogonal axis of the relatively short reciprocatory displacements is perpendicular to the longitudinal axis of the cutter tool.

80. The method of cutting according to claim 79, wherein, during each cutting stroke, a plurality of relatively short reciprocatory displacements are also produced between the cutter tool and the workpiece along a third orthogonal axis perpendicular to both the first and second orthogonal axes.

81. The method of cutting according to claim 76, wherein the workpiece is rotated about its longitudinal axis.

82. The method of cutting according to claim 81, wherein the second orthogonal axis of the relatively short reciprocatory displacements is parallel to the longitudinal axis of the cutter tool.

83. The method of cutting according to claim 76, wherein:
the workpiece is rotated about its longitudinal axis;
the second orthogonal axis of the relatively short reciprocatory displacements is parallel to the longitudinal axis of the cutter tool;
and the cutter tool has cutter edges which become oriented, during each cutting stroke, to generate: (a) a lateral force tending to move the cutter tool in the lateral direction perpendicularly to the longitudinal axis of the cutter tool; and (b) an axial force in the cutter tool imposing a substantial frictional resistance against movement of the cutter tool in the lateral direction.

84. The method of cutting according to claim 83, wherein the cutter edges generating lateral force (a) are defined by an outer surface of the cutter tool extending substantially parallel to the longitudinal axis of the cutter tool, and the cutter edges generating axial force (b) are defined by a plurality of slots in the cutter edges generating force (a) extending towards the longitudinal axis of the cutter tool.

85. The method of cutting according to claim 84, wherein the plurality of slots include a first group of slots extending a relatively long distance towards the longitudinal axis of the cutter tool, alternating with a second group of slots extending a relatively short distance towards the longitudinal axis of the cutter tool.

86. The method of cutting according to claim 76, wherein:
the cutter tool is rotated about its longitudinal axis;
the second orthogonal axis of the relatively short reciprocatory displacements is also perpendicular to the longitudinal axis of the cutter tool;
and the cutter tool holder has axially-extending cutter edges such that in each of the relatively short reciprocatory displacements, the displacement in each direction causes the cutting edges on the leading side and only on one lateral side of the cutter tool to engage the workpiece, thereby substantially decreasing the lateral force applied to the cutter tool, and accordingly, enabling the travel of the cutter tool with respect to the workpiece to be substantially increased.

87. The method of cutting according to claim 86, wherein the cutter edges include axially-extending cutter edges and radially-extending cutter edges.

88. The method of cutting according to claim 87, wherein the axially-extending cutter edges are spaced around the circumference of the cutter tool.

89. The method according to claim 76, wherein the relatively long unidirectional displacement and the relatively short reciprocatory displacements are such as to produce a displacement path constituted of short strokes at an angle of approximately 90° to each other.

90. The method according to claim 89, wherein the relatively long unidirectional displacement and the relatively short reciprocatory displacements are such as to produce a displacement path constituted of short strokes at an angle smaller than 90° to each other to thereby permit more material removal from the workpiece during each cutting stroke.

91. The method according to claim 76, wherein the drive system, during each cutting stroke, periodically interrupts the displacement of the cutter tool relative to the workpiece for a short period of time along the first orthogonal axis.

92. The method according to claim 91, wherein the drive system, during each of the interruptions, reverses the direction of the displacement along the first orthogonal axis for the short period of time, to separate the cutter edges of the cutter tool from the workpiece, to allow for better heat dissipation and thereby higher cutter speed during each cutting stroke.

93. The method according to claim 91, wherein the short period of time of the interruption along first the first orthogonal axis is less than one third of the time for the displacement along the first orthogonal axis during the respective cutting stroke.

94. A method of cutting a workpiece having a longitudinal axis comprising cutting the workpiece with a cutter tool, having a longitudinal axis, in one or more cutting strokes, each cutting stroke comprising:
(a) a relatively long unidirectional displacement between the cutter tool and workpiece along a first orthogonal axis; and
(b) periodical interruptions in the displacement of the cutter tool relative to the workpiece for short periods of time along the first orthogonal axis.

95. The method according to claim 94, wherein the drive system, during each of the interruptions, reverses the direction of the displacement along the first orthogonal axis for the short period of time, to separate the cutter edges of the cutter tool from the workpiece, to allow for better heat dissipation and thereby higher cutter speed during each cutting stroke.

96. The method according to claim 94, wherein the short period of time of the interruption along first the first orthogonal axis is less than one third of the time for the displacement along the first orthogonal axis during the respective cutting stroke.

97. The method according to claim 76, wherein the drive system rotates the cutter tool about its longitudinal axis.

98. The method according to claim 76, wherein the drive system rotates the workpiece about its longitudinal axis.
